(19) United States
(12) Patent Application Publication
(10) Pub. No.: US 2003/0141972 A1
(43) Pub. Date: Jul. 31, 2003

(54) Anti-theft device with a videotaping function

(76) Inventors: Thomas Yang, Hsin-Chu City (TW); Yi-Liang Lu, Taipei (TW)

Correspondence Address: Thomas Yang & Yi-Liang Lu, P.O Box No.6-57, Chung-Ho, TAIPEI 235, TW

(21) Appl. No.: 10/054,928

(22) Filed: Jan. 25, 2002

(51) Int. Cl. G08B 1/00

(52) U.S. Cl. 340/531; 340/539.17; 340/506; 348/152

(57) ABSTRACT

An anti-theft device with a videotaping function capable of videotaping a theft's looks and providing the police evidence to make an arrest or deterring thievery is basically equipped with an image sensor for inputting the captured image into a main unit connected with a detecting unit for detecting unusual situation and externally connected with an alarm device, a telephone, an information service provider of an Internet service provider (ISP) or a wireless communication provider; the image sensor is disposed at the best position; once an intruder enters the detecting area, the detecting unit informs the main unit to send out alarm, videotapes the intruder with preset taping method and informs the related individual; thereby, the outsider not only can view the intruder's looks through the network, but also can use the recorded data as evidence to prove against the criminal and as reference for the police to make an arrest.

### BACKGROUND OF THE INVENTION

1) Field of the Invention

The present invention relates to an anti-theft device with a videotaping function that aims to improve the conventional anti-theft device producing only the alarming sound to deter the theft but lacking an effective means of radically exterminating thievery; this device not only provides the conventional alarming function but also integrates with a network system to videotape for the purposes of serving as evidence in crime investigation and making an arrest, thereby to further enable a thorough eradication of thievery.

2) Description of the Prior Art

Accordingly, human desire exists since the beginning of the human race; undesirable desires cause one to engage in acts of stealing and such acts of stealing has been prevalent since ancient times in various countries; they are unmerited behavior caused by man's desire for material possessions that are available to others in their daily lives or for their own survival; with the development of technology, it is natural for man to seek dignity and respect in security, safety and privacy; various theft-prevention devices have been available in the markets to be used by families, factories, offices, vehicles and other facilities; with respect to locks, the manufacturers have exhausted all means to research for less-destructible, innovative and breakthrough locks to increase the sturdiness and unlocking structure thereof; with respect to electronic sensing anti-theft devices, there are generally seen devices that emit alarming sound to deter the burglar and other designs that dial in to the owner or the police station to assist in seizing the burglar; these are means that provide certain specified theft-prevention effects but fail to completely exterminate thievery, so they are limited to a certain extent; once the lock is damaged or the door is broken in, the expected theft-prevention effect is then removed; or, if the house owner is far away, the burglar could blatantly destroy the alarm device so as to thoroughly steal all valuables; even if the alarm device is effective, before the local policeman or the owner arrive at the scene, the burglar could have already left, leaving a scene that requires considerable expenses in repairs without a guarantee that a similar incidence will not happen again, or a guarantee that the same burglar will not visit again, as we have often seen reported that the habitual burglar returns to the crime scene repeatedly and is difficult to prevent.

This explains why in the country today, the theft occurrence level is high, but the burglar arrest level is low; only when a burglar is caught, can other unsolved burglaries perpetrated by the same burglar be known; therefore it is easy to know that the conventional anti-theft devices merely alleviate the burglary but not remove it, since the burglar will be long gone when the alarm goes off; such method of installing an anti-theft device can not catch the burglar in action, it is only a method of alleviating the symptoms without curing the problem of thievery; without capturing the burglar, the root survives to cause society a continuous theft problem.

The inventor of the present invention recognizes that the conventional anti-theft devices do not lead to a complete eradication of thievery in the society, mainly because the burglar's crime acts have not been publicized or been proven; therefore, even if one meets the burglar face to face, one may not be able to make a positive identification and such fact encourages the burglar to commit the crime again without the fear for burglar alarm devices; if failed in stealing, the burglar can simply try it again, not giving concerns to the possibility of being identified and that fuels the burglars to commit more crimes.

Therefore, this inventor believes that in order to completely eradicate thievery, it is necessary to record the burglar's looks so as to provide police evidence for making an arrest; thereby, burglars will find it hard to escape the law dragnet and will be brought to justice; the design of the present invention mainly aims to reduce the burglary level and increase the police crime solving level, thereby to afford citizens true protection in their daily lives and to completely eradicate the burglary occurrence.

### SUMMARY OF THE INVENTION

The first objective of the present invention of an anti-theft device with a videotaping function is to comprise both an image sensor with a videotaping function disposed at a proper location for taping the theft's entrance and a detecting unit to be connected with the main unit; when the others enter the room in an unusual way, the detecting unit informs the main unit to command an image sensor to videotape and send out alarm, then the theft's looks and behavior can be completely recorded by the image sensor to be used as evidence for the police to make an arrest.

The second objective of the present invention of an anti-theft device with a videotaping function is to connect the main unit with an information service provider, such as an Internet service provider (ISP) and a wireless communication provider to allow the related individual outsides to be able to control the situation at any time.

The third objective of the present invention of an anti-theft device is to allow the related individual to use a control unit to control the activation of the anti-theft device or check the indoor movement from outside.

To enable a further understanding of the structural features and the technical contents of the present invention, the brief description of the drawings below is followed by the detailed description of the preferred embodiment.

### BRIEF DESCRIPTION OF THE DRAWINGS

FIG. 1 is an operation flow chart of the present invention.

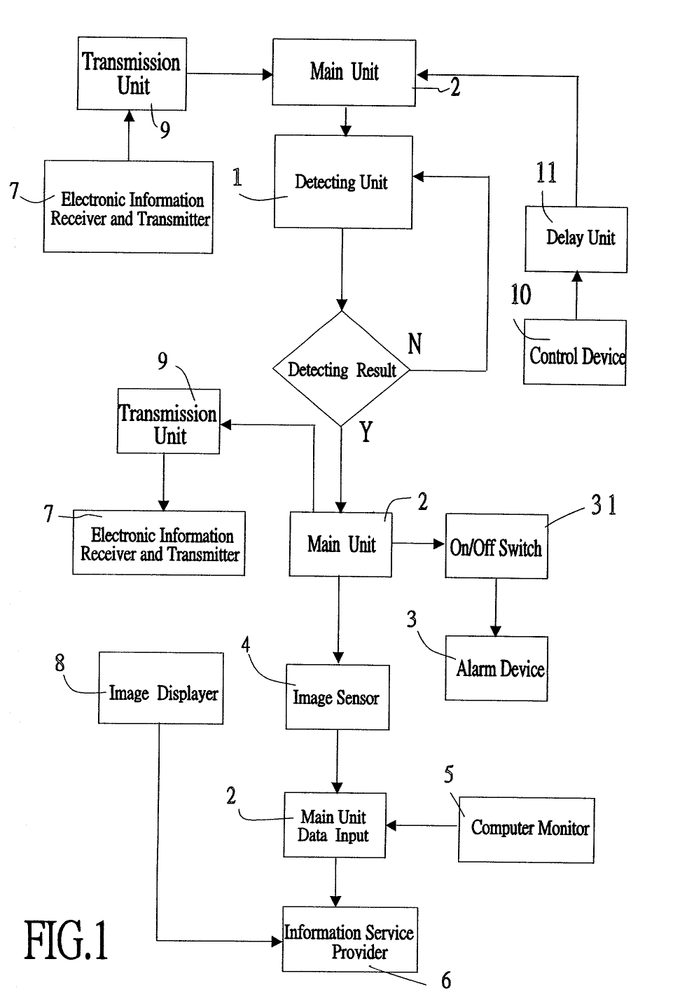

### DETAILED DESCRIPTION OF THE PREFERRED EMBODIMENTS

The present invention of an anti-theft device mainly comprises, according to the need, at least a detecting unit (1), a main unit (2), an alarm device (3), an image sensor (4), a computer monitor (5), an electronic information receiver and transmitter (7), an image displayer (8), a transmission unit (9) and a control device (10); wherein, the main unit (2) can be connected with an information service provider (6), such as an Internet service provider (ISP) or a wireless communication provider; the said detecting unit (1) can be set according to the need as an infrared sensor to be activated whenever an unidentified object passes by, as a vibration sensor to be activated under an unusual force, as a micromotion switch or an image identifier to be activated whenever a door or a window is opened, a lock is unlocked or a steering wheel is turned; generally, the infrared sensor is the best detecting device for a residence because the variation of the light thereof is more stable and the distance is short unlike the outdoor might be activated by a sudden light source; for a vehicle, the micromotion switch is the best choice; it can be connected to a concealed location not easy to find, such as the keyhole or the steering wheel of the vehicle; for a big factory, the vibration sensor is the best for a large area and it will be activated whenever the iron rolling door is pulled upwardly.

The image sensor (4) can be selected according to the anti-theft location; for a small residence or vehicle, the pin-hole video camera is preferred and not easy to be found or damaged; since the theft might be a regular guest to the targeted house, so it is better to conceal the camera behind the door and the window at the main entrance with a proper distance, or at any position possible for videotaping the theft's looks; in a vehicle, in order to catch a front view of the theft's looks, it is better to dispose the camera at the upper aspect of the driver's seat, at a concealed location or to disguise it as an ornament; for a factory, a small video camera is selected for better taping distance; a plurality of cameras can be disposed at different pathways and the data thereof is input into the main unit (2) as a digitized image.

Wherein, the main unit (2) can be activated manually onsite or by dialing in the preset password through a telephone from outside; the password identified valid by the transmission unit (9) activates the main unit (2); the said transmission unit (9) is connected with the telephone for identifying the input password and taking command to activate the dialing; in addition to connecting with the detecting unit (1) and the image sensor (4), the main unit (2) can further connect with the information service provider (6), such as an ISP or a wireless communication provider for sending the data recorded by the image sensor (4) back to the main unit (4) for storing as a digitalized image; at the same time, the data is transmitted to a service mailbox preset by the information service provider (6); furthermore, the main unit (2) is also connected with the alarm device (3) and the transmission unit (9); once the detecting unit (1) detects any unusual situation, the main unit (2) not only activates the image sensor (4), but also makes the alarm device (3) sent out the alarm and transmits the signals to the electronic information receiver and transmitter (7) by means of the transmission unit (9) for informing the related individuals, such as the owner or a district police officer; the electronic information receiver and transmitter (7) can be a regular wired telephone, a wireless mobile phone or a sound generator for receiving signals.

Wherein, the said alarm device (3) can be set to generate the sound for a long or a certain time; for the common residence without any connection with a district police officer or a managing personnel, a short alarming time is set; if connected with a district police officer or a managing personnel, a long alarming time is set; when the district police officer or the managing personnel arrive at the scene, the on/off switch (31) is turned off to cut the electricity source for the alarm device (3) and the connection with the main unit (2); to avoid disturbing the neighbors, the alarm is preferred to set on for about one to two minutes just long enough for scaring away the theft; even if the theft is aware of the location of the on/off switch (31) and turns it off to just stop the alarming sound of the alarm device (3), the videotaping procedure is still going on; the normal anti-theft detecting function will not be ended or resumed until the owner is back, or, once informed outdoors and understood the police officer's process, the owner activates again the anti-theft device into a normal operating state by means of the electronic information receiver and transmitter (7); this control can be done by inputting the preset password through telephone dialing; after being identified by the transmission unit (9), the anti-theft detecting function of the main unit (2) can be activated; after taking care of the incidence, the police officer can directly activate the alarm device (3) to continue the alarming and anti-theft function; however, at this time, the image sensor (4) is still operating, the own, although not being able to be home in time, once informed by the main unit (2) and the police officer, can again activate the main unit (2) by telephone dialing to make the detecting unit (1) resume the detection and the image sensor (4) follow the command of the main unit (2); of course, it can be set to automatically self-activate after the alarm is on for a certain period of time so as to save the owner's remote control.

In addition to sending out a long alarm, the alarm device (3) can be set with a recording for a shot time to warn the person entering the room and to prevent the owner from forgetting to turn off the alarm system; once the detecting unit (1) detects any unusual movement, it will not only videotape, but also send out the recorded warning, for example, “This is a warning. You already activated the videotaping system and all of your behaviors will be videotaped wirelessly on the network. If failed to leave within three minutes, another alarm will be activated.” The owner will know how to turn off the alarm system right away, but a theft will be scared to leave; if not connected with the district police, the alarm device (3) can be designed to allow the detecting unit (1) to automatically resume the detecting state once the alarming sound ends and the image sensor (4) takes the command to videotape again; this objective not only saves the owner's remote control, but also prevents the reentrance of the same theft or the entrance of another theft once it has been noticed that actually no one will come after the alarm device (3) is activated and the action is videotaped at the first time; therefore, the alarm device (3) is set to resume automatically to continuously detect a short wile after the alarm is on so as to videotape every entered theft or stranger to be used as reference for the police; the videotaping method of the image sensor (4) can be set for fulltime taping or scheduled taping; if the main unit (2) is not set to automatically resume to activate, when the intruder enters and the owner is informed to turn on the image device (8) to check the room situation, the owner can use a telephone to dial and command the main unit (2) to resume to the normal detecting state after the theft leaves; therefore, the videotaping will not be on when the alarm device (3) is turned off.

Furthermore, when the main unit (2) finds an unusual situation, the design of using the transmission unit (9) to inform the owner or the district police officer can be adapted by using a wireless transmitter to inform the owner's portable receiver.

The present invention of an anti-theft device with a videotaping function concerns the situations including the absence of the owner and the damage of the main unit (2); to connect the main unit (2) with the information service provider (6), such as an ISP or a wireless communication provider, the recorded data can be transmitted to a mailbox preset at the information service provider for saving; thereby, the owner can check through the image displayer (8) from outside; the said image displayer (8) can be connected with the information service provider (6), such as an ISP or a wireless service provider by means of a personal digital assistant (PDA), a notebook computer, a mobile phone or a desktop computer for obtaining the recorded image data of the theft; or, the owner can use a personal computer monitor (5) connected with the main unit (2) to view the theft's behavior for reporting to the police; therefore, even the main unit (2) is damaged, the mailbox of the information service provider (6), such as an ISP or a wireless communication provider, still have the saved criminal evidence; the owner staying outside can also dial in the password through a electronic information receiver and transmitter (7) to view the indoor activity; after identifying the password and informs the main unit (2), the transmitting unit (9) commands the image sensor (4) to live record and transmit the data to the information service provider (6), then the owner can view the image on an image displayer (8).

In order to convenience the owner going outdoors to activate the anti-theft device from a short distance, in addition to dialing through a mobile phone, a control unit (10) with a wireless receiving function is disposed on the main unit (2) for using wireless or infrared remote controller to remote control the controller (10); thereby, when being away from the surveillant site, the owner can use the remote controller to activate the anti-theft system; if wired connected indoors, another delay unit (11) is disposed on the control unit (10) to give the owner enough time to leave before the anti-theft system starts to operate anti-theft detection; therefore, the said control device (10) can be a regular infrared or wireless receiving unit switch to be controlled just by a remote controller, or a wired controlling switch disposed according to the user's need.

It is thereby understood that the present invention of an anti-theft device with a videotaping function possesses the following functions of:

1. Being able to videotape the theft's looks in time by means of an image sensor and record to the main unit and the information service provider, such as an ISP or a wireless communication provider.

2. Being convenient and simple to handle not limited by the site but installed according to the need.

3. Being able to make updating surveillance to record the theft's behavior to the information service provider's mailbox instantly to avoid disappearance due to the damage at the scene.

4. Being able to actively deliver voice warning and having the effect of reporting to the district police and the owner immediately.

5. Recording the theft's behavior as the evidence for making an arrest later on.

6. Being able to surely and completely save the evidence of the theft's behavior starting from entering the room at the information service provider without being damaged, even if the anti-theft device on the site is damaged.

7. Recording a certain voice warning toward the intruder's criminal behavior and giving the owner enough time to turn off the on/off switch to avoid accidentally activating the alarm.

8. Allowing the owner to control and monitor the activities at the scene from outside.

In summation of the abovementioned, the present invention of an anti-theft with a videotaping function outbreaks the shortcomings of the traditional anti-theft device good only for scaring but failed to practically arrest the theft and eradicate the crime by fulfilling the functions of arresting and scarring to completely achieve the objective of really preventing and arresting the theft as well as eradicating thievery.

It is of course to be understood that the embodiment described herein is merely illustrative of the principles of the invention and that a wide variety of modifications thereto may be effected by persons skilled in the art without departing from the spirit and scope of the invention as set forth in the following claims.

1. An anti-theft device with a videotaping function comprises:
a detecting unit capable of detecting the unusual situation at the surveillant area;
a main unit controlling an alarm device, a transmission unit, an image sensor and connecting with an information service provider; after detecting an unusual situation, the detecting unit informs the main unit to activate the alarm device, the transmission unit and the image sensor;
an image sensor videotaping according to the predefined method after receiving the command from a main unit;
a transmission unit identifying the signal of a dialed-in code from outside to command the main unit to act or to transmit the signal to an electronic receiver and transmitter;
an electronic receiver and transmitter receiving the signal from the transmission unit or transmitting the signal to the transmission unit through electronic dialing;
an image displayer connected with the information service provider for viewing the image videotaped by the image sensor;
a controlling device connected with a main unit to control the activation of the anti-theft device;
when the owner, being away or outside, uses the control device or the electronic receiver and transmitter to activate the anti-theft device, the detecting unit starts to detect; once detected an unusual situation, the main unit activates the alarm device, the image sensor and the transmission unit to act; the recorded data is not only saved at the main unit, but also transmitted to the information service provider through the main unit; the owner or the related individual outside can also view the recorded data from the image displayer connected with the information service provider.

2. An anti-theft device with a videotaping function according to claim 1, wherein the said control device can be wired to directly activate the main unit wirelessly.

3. An anti-theft device with a videotaping function according to claim 1, wherein the said control device can have a wired on/off switch for directly controlling the activation of the main unit.

4. An anti-theft device with a videotaping function according to claim 1 or 3, wherein a delay unit can be disposed between the control device and the main unit for delaying the activation of the anti-theft device in order to give the owner enough time to leave from activating the control device.

5. An anti-theft device with a videotaping function according to claim 1, wherein an on/off switch can be disposed between the said alarm device and the main unit.

6. An anti-theft device with a videotaping function according to claim 1, wherein the detecting unit can be set to resume to the detecting state when the alarm action stops.

7. An anti-theft device with a videotaping function according to claim 1, wherein the activated image sensor can be set to videotape for a long time.

8. An anti-theft device with a videotaping function according to claim 1, wherein the activated image sensor can be set for a single photo shooting.

9. An anti-theft device with a videotaping function according to claim 1, wherein the said transmission unit is connected with another telephone for identifying the input password from outside or actively dialing the number under a command.

10. An anti-theft device with a videotaping function according to claim 1, wherein the said electronic receiver and the transmitter can be a wired telephone for receiving signals.

11. An anti-theft device with a videotaping function according to claim 1, wherein the said electronic receiver and the transmitter can be a wireless mobile phone for receiving signals.

12. An anti-theft device with a videotaping function according to claim 1, wherein the said electronic receiver and the transmitter can be a sound generator for receiving signals.

13. An anti-theft device with a videotaping function according to claim 1, is able to connect with the information service provider for obtaining the videotaped image data.
